(19) United States
(12) Patent Application Publication
(10) Pub. No.: US 2015/0039748 A1
(43) Pub. Date: Feb. 5, 2015

(54) NETWORK STATE SERVER FOR APPLICATION PROVIDERS

(71) Applicant: Verizon Patent and Licensing Inc., Arlington, VA (US)

(72) Inventors: Sagiv Draznin, Walnut Creek, CA (US); Arda Aksu, Martinez, CA (US); Yee Sin Chan, San Jose, CA (US); David Chiang, Fremont, CA (US); Lalit R. Kotecha, San Ramon, CA (US)

(73) Assignee: VERIZON PATENT AND LICENSING INC., Arlington, VA (US)

(21) Appl. No.: 13/954,716

(22) Filed: Jul. 30, 2013

(51) Int. Cl. H04L 12/26

(52) U.S. Cl. CPC H04L 43/10
USPC 709/224

(57) ABSTRACT

State information relating to an operational state of a network may be provided to services, such as services provided by application servers, and used to enhance the providing of the services to devices. In one implementation, the state information may be received and may include: (1) information relating to the operational state of a particular portion of a network; or (2) information relating to the operational state of the network as relevant to a particular mobile device connected to the network. A request for the state information may be received from an application server that provides services based on the state information. The request may include an identification of the particular portion of the network or an identification of the particular mobile device. The requested state information may be provided to the application server.

### BACKGROUND

Wireless networks, such as cellular wireless networks, may provide network connectivity to mobile devices, such as smart phones. The mobile devices may connect to other devices, such as application servers within a packet data network connected to the wireless network, to receive applications or services. For example, a content provider may operate content servers that stream on-demand video content to the mobile devices. Other services, provided by application servers, may relate to, for example, social networking, gaming, machine-to-machine services, or other services.

The perceived quality of the applications or services, provided by the application servers, may vary based on the quality of the network connections between the application servers and the mobile devices. Further, some applications or services may be more heavily dependent on high quality network connections than other applications or services. For example, a provider of streaming video content may require a minimum end-to-end bandwidth, between the application server and the mobile devices, in order to effectively provide the streaming video content.

### BRIEF DESCRIPTION OF THE DRAWINGS

FIG. 1 is a diagram conceptually illustrating an example of an overview of concepts described herein;

FIG. 2 is a diagram of an example environment in which systems and/or methods described herein may be implemented;

FIG. 3 is a diagram illustrating on example implementation of a wireless network;

FIGS. 4A and 4B are diagrams illustrating example data structures;

FIG. 5 is a flowchart illustrating an example process for providing network state information to application servers;

FIG. 6 is a flowchart illustrating an example process for providing application services or data to mobile devices;

FIG. 7 is a diagram illustrating one particular example of an application server providing services based on network state information that is received from a network state server;

FIG. 8 is a diagram illustrating an example system in which network state information may be maintained by a mobile device;

FIG. 9 is a flowchart illustrating an example process for providing network state information to application servers; and

FIG. 10 is a diagram of example components of a device.

### DETAILED DESCRIPTION OF PREFERRED EMBODIMENTS

The following detailed description refers to the accompanying drawings. The same reference numbers in different drawings may identify the same or similar elements.

As described herein, a network provider may make an application programming interface (API) available to third-party application providers, through which the third-party application providers can obtain information relating to an operational state of a network. For example, a network provider, that manages a wireless network, may operate a network state server that receives network state information from mobile devices connected to the wireless network, base stations in the wireless network, or other network devices associated with the wireless network. Third-party application providers, when providing services to the mobile devices, may query the network state server to obtain network state information that is relevant to the mobile devices that are being serviced by the third-party application providers. The third-party application providers may then customize or optimize, based on the received network state information, the services provided to the mobile devices.

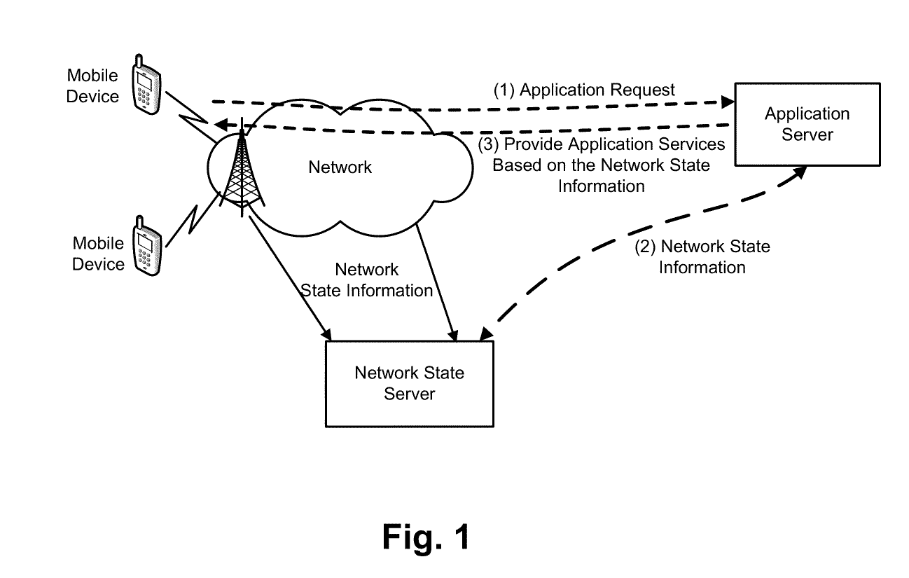

FIG. 1 is a diagram conceptually illustrating an example of an overview of concepts described herein. As shown in FIG. 1, mobile devices, such as smart phones, may obtain services from an application server (e.g., a server that is operated by a third-party (i.e., a party that is not an operator of the network) application provider). A network state server may maintain network state information relating to the operation of a network. The network state information may include, for example, information relating to the quality of the radio connection between the mobile devices and base stations of the network, congestion levels of the network, latency associated with the network, and/or operational state of network devices (e.g., routers, switches, and/or control devices). In some implementations, the network state information may be maintained on a relatively high-level basis. For example, the state information may generally indicate network operational information relating to the network or to portions of the network (e.g., the operational information may be separately maintained based on geographic regions). Alternatively or additionally, the network state information may be available on a more fine-grained basis. For example, the network state information may indicate network operational information (e.g., radio connectivity, network bandwidth, and/or latency) as applied to a particular mobile device or base station.

As illustrated in the example of FIG. 1, a mobile device may communicate, through the network, to obtain services from an application server (communication (1), Application Request). The application server may, as part of providing the application services to the mobile device, query the network state server to obtain network state information (communication (2), Network State Information). The network state information may relate to a general operational state of the network (or portions of the network) and/or to particular network conditions being experienced by the mobile device. The application server may communicate with the network state server through one or more APIs provided by the network state server. The obtained network state information may be used to provide the application services to the mobile device. For example, based on network state information relating to the throughput that is likely to be available for the mobile device, the application server may optimize (e.g., use a compression level appropriate for the available throughput) the delivery of streaming multimedia content to the mobile device. As another example, based on network state information relating to the latency that is likely to be experienced by the mobile device, an application server that provides an online gaming service to the user of the mobile device, may optimize the gaming experience based on the obtained latency information.

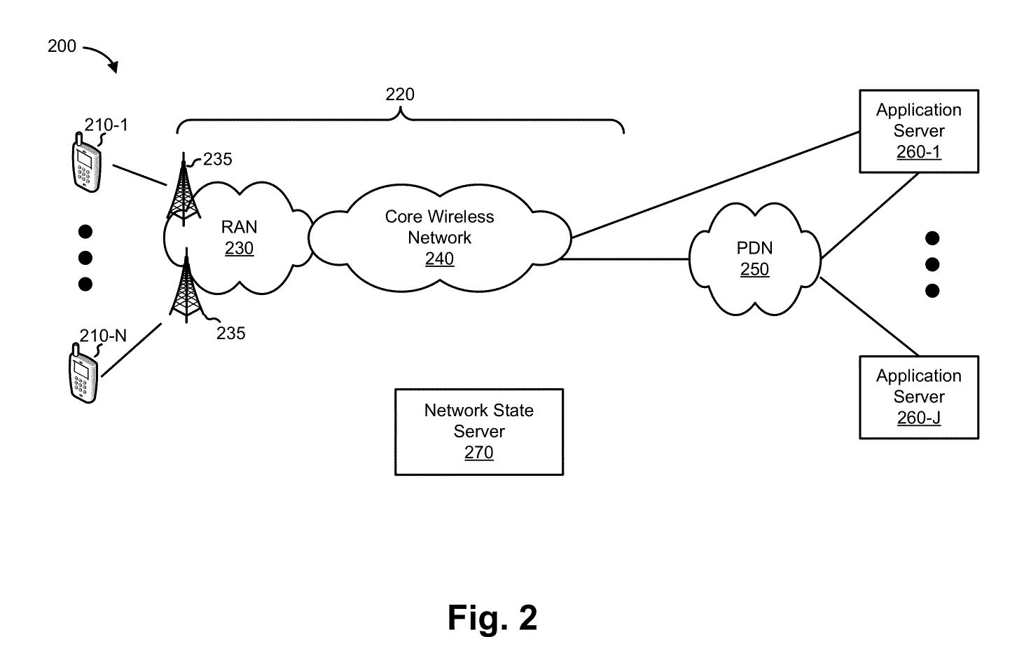

FIG. 2 is a diagram of an example environment 200 in which systems and/or methods described herein may be implemented. As illustrated, environment 200 may include one or more mobile devices 210-1 through 210-N (referred to collectively as “mobile devices 210” or singularly as “mobile device 210”). Mobile devices 210 may obtain network connectivity through wireless network 220 (e.g., a cellular network). Wireless network 220, as illustrated, may include radio access network (RAN) 230 and wireless core network 240. An additional network or networks, such as a packet data network (PDN) 250 may provide connectivity to application servers 260-1 through 260-J (referred to collectively as “application servers 260” or singularly as “application server 260”). Additionally, network state server 270 may maintain network state information relating to the operation of wireless network 220 and/or to the operation of other devices or networks.

Mobile devices 210 may include portable computing and communication devices, such as a personal digital assistant (PDA), a smart phone, a cellular phone, a laptop computer with connectivity to a cellular wireless network, a tablet computer, etc. Mobile devices 210 may also include non-portable computing devices, such as desktop computers, consumer or business appliances, set-top devices (STDs), or other devices that have the ability to connect to RAN 230. Mobile devices 210 may connect, through a radio link, to RAN 230. Through the radio link, mobile devices 210 may obtain data and/or voice services, such as services provided by application servers 260.

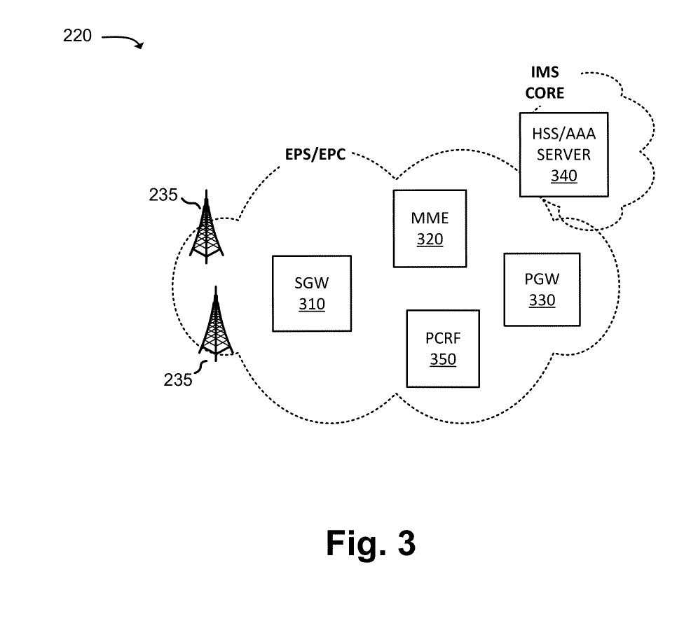

RAN 230 may include one or more devices that include radio interfaces to provide wireless connections to mobile devices 210. RAN 230 may provide wireless connectivity for wireless network 220. RAN 230 may include, for example, one or more base stations 235. Each base station 235 may provide one or more radio interfaces over which the base station may communicate with mobile devices 210. The radio interfaces may include, for example, orthogonal frequency-division multiplexing (OFDM) and/or single-carrier frequency-division multiple access (SC-FDMA) based radio interfaces. In the context of a network such as a long term evolution (LTE) network (e.g., as illustrated in FIG. 3), base stations 235 may be referred to as evolved Node Bs (eNodeBs).

Core wireless network 240 may implement a network that provides routing, control, and data transmission services for mobile devices 210. Core wireless network 240 may connect to one or more other networks, such as to PDN 250 (e.g., the Internet), to provide network services to mobile devices 210. Core wireless network 240 may include one or more network devices used to implement control logic, physical links, and routing/switching functions that may be performed by core wireless network 240. In one implementation, core wireless network 240 may implement an LTE network.

PDN 250 may include one or more packet networks, such as an Internet Protocol (IP) based packet network. PDN 250 may include a wide area network (WAN), a local area network (LAN), and/or combinations of WANs and LANs. Mobile devices 210 may access PDN 250 to obtain computation and/or data services from computing devices, such as application servers 260.

Application servers 260 may include one or more computation and communication devices that provide data and/or computing services to connecting devices, such as to mobile devices 210. Application servers 260 may connect, to mobile devices 210, through PDN 250 and/or directly through wireless network 220. Application server 260 may include, for example, a web server, a file server, a gaming server, a social media server, or another type of server. As will be described in more detail below, when communicating with mobile devices 210 to provide services requested by mobile devices 210, application servers 260 may obtain network state information, relating to an operational state of wireless network 220 (or portions of wireless network 220). The network state information may be used to optimize and/or enhance the application services provided to mobile devices 210. In general, application server 260 may refer to any device, or set of devices, that provides data or services to mobile devices 210.

Network state server 270 may include one or more computation and communication devices that operate to maintain network state information, such as information relating to the operational state of wireless network 220, and provide the network state information to application servers 260. Network state server 270 may receive information regarding the network operational state from a number of network devices that may be associated with a network, such as wireless network 220. The network devices may include mobile devices 210, base stations 235, network devices that handle control traffic in wireless network 220, network devices that handle bearer traffic in wireless network 220, and/or other network devices. In one implementation, information received by network state server 270 may be information that has been collected and/or received as part of the operation of mobile devices 210 and/or wireless network 220. Thus, in this implementation, network state server 270 may be implemented without requiring implementation of additional data collection functions in environment 200. The operation of network state server 270 will be described in more detail below.

Although network state server 270 is illustrated, in FIG. 2, as a separate element in environment 200, in some implementations, network state server 270 may be implemented within wireless network 220, within another network, and/or as functionality performed by another network device. Additionally, in other implementations, environment 200 may contain fewer components, different components, differently arranged components, or additional components than those depicted in FIG. 2. Alternatively, or additionally, one or more components of environment 200 may perform one or more other tasks described as being performed by one or more other components of environment 200.

FIG. 3 is a diagram illustrating on example implementation of wireless network 220. As illustrated, wireless network 220 may include a network implemented based on the LTE standard. In other possible implementations, wireless network 220 may be implemented based on other standards or technologies.

As shown in FIG. 3, wireless network 220 may include base stations 235 (e.g., eNodeBs), a serving gateway (SGW) 310, a mobility management entity device (MME) 320, a packet data network gateway (PGW) 330, a home subscriber server (HSS)/authentication, authorization, accounting (AAA) server 340 (hereinafter referred to as “HSS/AAA server 340”), and a policy charging and rules function (PCRF) 350.

The quantity of devices and/or networks, illustrated in FIG. 3, is provided for explanatory purposes only. In practice, there may be additional devices and/or networks; fewer devices and/or networks; different devices and/or networks; or differently arranged devices and/or networks than illustrated in FIG. 3. Alternatively, or additionally, one or more of the devices shown in FIG. 3 may perform one or more functions described as being performed by another one or more of the devices of FIG. 3. The devices of FIG. 3 may interconnect via wired connections, wireless connections, or a combination of wired and wireless connections.

Wireless network 220 may include an evolved packet system (EPS) that includes a LTE network and/or an evolved packet core (EPC) network that operate based on a third generation partnership project (3GPP) wireless communication standard. The EPS/EPC network may one or more SGWs 310, MMEs 320, PGWs 330, and/or PCRFs 350, and may enable mobile devices to communicate with PDN 250 (FIG. 2) and/or an IP multimedia subsystem (IMS) core network. The IMS core network may include HSS/AAA server 340.

SGW 310 may include one or more network devices that gather, process, search, store, and/or provide information in a manner described herein. SGW 320 may, for example, aggregate traffic received from one or more base stations 235 and may send the aggregated traffic to PDN 250 via PGW 330.

MME 320 may include one or more computation and communication devices that gather, process, search, store, and/or provide information in a manner described herein. For example, MME 320 may perform operations to register mobile devices 210 with the EPS, to establish bearer channels associated with a session with mobile devices 210, to hand off mobile devices 210 from the EPS to another network, to hand off mobile devices 210 from the other network to the EPS, and/or to perform other operations. MME 320 may perform policing operations on traffic destined for and/or received from mobile devices 210.

PGW 330 may include one or more network devices, or other types of computation and communication devices, that gather, process, search, store, and/or provide information in a manner described herein. PGW 330 may aggregate traffic received from one or more SGWs 310, etc. and may send the aggregated traffic to PDN 250. PGW 330 may additionally, or alternatively, receive traffic from PDN 250 and may send the traffic toward mobile devices 210 via SGW 310 and/or base stations 235.

HSS/AAA server 340 may include one or more server devices, or other types of devices, that gather, process, search, store, and/or provide information. For example, HSS/AAA server 340 may manage, update, and/or store, in a memory associated with HSS/AAA server 340, profile information associated with a subscriber. The profile information may identify applications and/or services that are permitted for and/or accessible by the subscriber; a mobile directory number (“MDN”) associated with the subscriber; bandwidth or data rate thresholds associated with the applications and/or services; information associated with the subscriber (e.g., a username, a password, etc.); rate information; minutes allowed for a subscriber; and/or other information. The subscriber may be associated with mobile device 210 and/or one or more other mobile devices 210. Additionally, or alternatively, HSS/AAA server 340 may perform authentication, authorization, and/or accounting operations associated with the subscriber and/or a communication session with mobile device 210.

PCRF 350 may include one or more server devices, or other types of devices, that aggregate information to and from the EPC network and/or other sources. PCRF 350 may receive information regarding policies and/or subscriptions from one or more sources, such as subscriber databases and/or from one or more users (such as, for example, an administrator associated with PCRF 350).

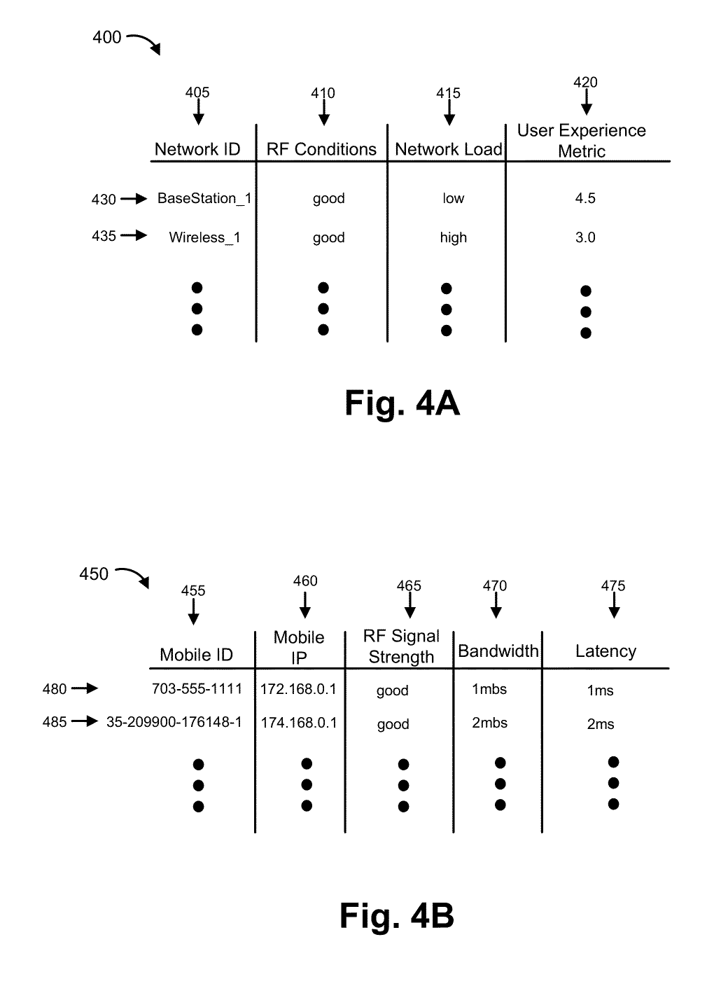

As previously mentioned, network state server 270 may receive network state information from devices associated with wireless network 220. In some implementations, the network state information may alternatively or additionally be associated with other devices and/or networks, such as from devices in PDN 250. FIGS. 4A and 4B are diagrams illustrating example data structures 400 and 450, such as data structures that may be maintained by network state server 270. Data structures 400 and 450 may generally be used to store the network state information that is received by network state server 270. The fields shown for data structures 400 and 450 are examples. In alternative possible implementations, different, fewer, or additional fields may be implemented. Further, in various implementations, network state server 270 may implement one or both of data structures 400 and 450.

Data structure 400 may be used to store network state information relating to the operational state of a network or of a portion of a network. For example, wireless network 220 may include a cellular wireless network that covers a large geographical area (e.g., a state or country). Data structure 400 may include records corresponding to different geographical coverage areas of wireless network 220. Different geographical coverage areas may be areas that correspond to the areas covered by particular base stations 235 (e.g., network cells), to geographical areas grouped by population density (e.g., a city may correspond to a network portion), to geographical areas served by particular routers, SGWs 310, or other network devices, or to other divisions of wireless network 220 or to other networks. Through data structure 400, network state server 270 may maintain relatively high-level information about the current operational state of one or more networks.

As illustrated in FIG. 4A, data structure 400 may include a number of fields, such as: network identification (ID) field 405, radio frequency (RF) conditions field 410, network load field 415, and user experience metric field 420. Network ID field 405 may include information that identifies a particular network or network portion that corresponds to a record in data structure 400. A number of techniques can be used to identify a network or network portion. For example, identifiers corresponding to base stations 235 may be used when each network portion corresponds to the coverage area of a base station. In other possible implementations, geographic information (e.g., an area specified by latitude and longitude values or specified using other identifiers, such as based on the coverage area corresponding to a telephone area code or to a ZIP code) may be used for each record, in data structure 400, to identify the relevant network or network portion.

RF conditions field 410 may include an indication of the radio conditions associated with the corresponding record in data structure 400. For example, when the value for network ID field 410 corresponds to an area covered by a particular base station 235, RF conditions field 410 may include information regarding the average received signal strength of the mobile devices connected to the base station or some other metric indicating the RF conditions associated with the particular base station 235. Network load field 415 may include an indication of the network load associated with the corresponding record in data structure 400. For example, when the value for network load field 415 corresponds to an area covered by a particular base station 235, network load field 415 may include a value indicating a level of congestion experienced by the particular base station 235 (e.g., a value corresponding to the congestion state of queues and/or a scheduler of the particular base station 235).

User experience metric field 420 may include an indication of the overall user experience of a user that is using a mobile device associated with the corresponding record in data structure 400. The value of user experience metric field 420 may be a meta-value that is based on a number of lower level network metrics. For example, user experience metric field 420 may be based on RF conditions in the corresponding network or network portion, an average load in the corresponding network or network record, the average received signal strength of the mobile devices connected to the base station, and/or or some other metric indicating the RF conditions associated with the particular base station 235. User experience metric field 420 may, in general, be a single value that provides an indication of an overall network state, of the relevant network or network portion. Application servers 270 may use user experience metric field 420 as a concise measurement of the state of the corresponding network or network section.

Two example records are illustrated in data structure 400. Record 430 may correspond to network state information of the portion of a network associated with a particular base station (“BaseStation_{—}1”), and record 435 may correspond to network state information for a particular network, labeled as network “Wireless_{—}1”. As shown, for record 430, the RF conditions (in RF conditions field 410) are illustrated as “good” and the network load (in network load field 415) is given as “low.” The user experience metric (in user experience metric field 420) is given as “4.5,” which may be, for example, on a scale of one (worst user experience) to five (best user experience). It can be appreciated that in alternative implementations, different representations may be used for the values in fields 405-420. For example, values for RF conditions field 410 and network load field 415 may be provided on a numeric scale (e.g., on a scale from one to five, as a value representing a signal to noise ratio (for RF conditions field 410), or as a value representing a current total throughput of a network element (for network load field 415)). Similarly, as shown for record 435, the RF conditions (in RF conditions field 410) are illustrated as “good” and the network load (in network load field 415) is given as “high.” In alternative possible implementations, the values in RF conditions field 410 and network load field 415 may be represented using numeric values. The user experience metric (in user experience metric field 420) is given as “3.0.”

Data structure 450 may be used to store network state information relating to the operational state of a network as the operational state is relevant to particular mobile device. For example, data structure 450 may include records corresponding to mobile devices attached to wireless network 220. The information in data structure 450 may be obtained, for example, from mobile devices 210 and/or from network elements in wireless network 220 (e.g., base stations 235).

As illustrated in FIG. 4B, data structure 450 may include a number of fields, such as: mobile identification (ID) field 455, mobile IP field 460, RF signal strength field 465, bandwidth field 470, and latency field 475. Mobile ID field 455 may include information that identifies a mobile device 210. Values of mobile ID field 455 may include, for example, mobile device telephone numbers, mobile device international mobile equipment identity (IMEI) values, a mobile equipment identifier (MEID), or another mobile device identifier. Mobile IP field 460 may include an IP address assigned to the corresponding mobile device, such as an IP address assigned to the mobile device, by wireless network 220, when communication with PDN 250.

RF signal strength field 465 may include an indication of the signal strength received by mobile device 210. Values for RF signal strength field 465 may be obtained and transmitted, by mobile device 210, to network state server 270. Alternatively or additionally, other devices in wireless network 220, such as a base station 235, may obtain and transmit, to network state server 270, the indication of the signal strength received by the mobile device. Bandwidth field 470 may include an indication of the bandwidth available at mobile device 210. For example, bandwidth field 470 may indicate an aggregate bandwidth that may be delivered, to mobile device 210, by wireless network 220. In some implementations, bandwidth field 470 may indicate the excess bandwidth (e.g., the bandwidth that can be provided to mobile device 210 in addition to any other communication sessions in which mobile device 210 is engaged) that can be delivered to mobile device 210. In some implementations, the value for bandwidth field 470 may be obtained or calculated from network information received from one or more devices in wireless network 220, such as from mobile device 210, base station 235, and PGW 330.

Latency field 475 may include an indication of latency being experienced by mobile device 210. Latency may be measured between, for example, mobile device 210 and another device, such as PGW 330. Latency may be determined, for example, based on a device, such as a mobile device 210, measuring the time required for a device, such as PGW 330, to respond to a packet transmitted from mobile device 210 (e.g., a network ping message).

Two example records are illustrated in data structure 450. Record 480 may correspond to network state information for a first mobile device and record 485 may correspond to network state information for a second mobile device. As shown, record 480 may be a record for the mobile device with the telephone number “703-555-1111” (mobile ID field 455) and having an IP address “172.168.0.1” (mobile IP field 460). The RF signal strength, for record 480, is “good” (RF signal strength field 465), the bandwidth is indicated as 1 mbs (one mega-bits per second) (bandwidth field 470), and the latency is indicated as 1 ms (latency field 475), which may indicate the round trip time for a packet to travel from a mobile device 210, to another device (e.g., PGW 330), and back to mobile device 210. Record 485 may correspond to a mobile device having the IMEI value “35-209900-176148-1” and an IP address “174.168.0.1”. The RF signal strength, for record 480, is “good,” the bandwidth is indicated as 2 mbs, and the latency is indicated as 2 ms.

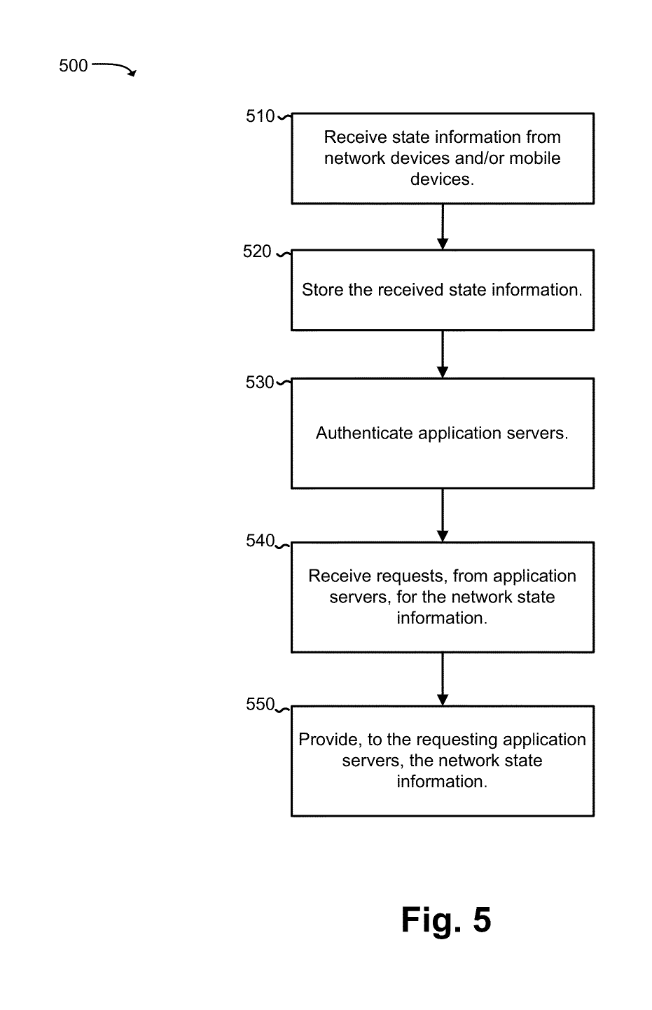

FIG. 5 is a flowchart illustrating an example process 500 for providing network state information to application servers 260. Process 500 may be performed, for example, by network state server 270.

Process 500 may include receiving state information from network devices and/or mobile devices (block 510). As discussed previously, network state server 270 may receive network state information that may relate to the operational state of a network, a section of the network, and/or mobile devices attached to the network. The state information may generally relate to the ability of mobile devices 210 to receive and/or transmit data. As discussed with reference to data structure 400 and 450 (FIG. 4), the state information may include information relating to RF conditions, network load, bandwidth availability, latency, or other information.

Process 500 may further include storing the received state information (block 520). For example, network state server 270 may maintain one or more databases to store the state information. In some implementations, the databases may store the state information in data structures, such as data structure 400 and/or data structure 450. In some implementations, network state server 270 may process and/or analyze the state information before storing the state information. For example, network state server 270 may aggregate latency information, corresponding to a number of network segments in wireless network 220, to store an end-to-end latency value corresponding to a particular mobile device or a particular network segment.

Process 500 may further include authenticating application servers (block 530). In some implementations, only certain application servers 260, such as those approved by an operator of wireless network 220, may be allowed to access the information in network state server 270. For example, the operator of wireless network 220 may wish to validate operators of application servers 260 to ensure that network state information, obtained from network state server 270, is being used in a permissible manner. Additionally, in some implementations, the operator of wireless network 220 may charge for the use of the data maintained by network state server 270. Accordingly, it may be desirable to authenticate application servers 260 that wish to interact with network state server 270.

Process 500 may further include, receiving requests, from application servers, for the network state information (block 540). As mentioned, application servers 260 may use network state information to enhance or optimize services or data delivered to mobile devices 210. In one implementation, network state server 270 may provide an API for application servers 260, through which application servers 260 may access the network state information. For example, the API may include methods to request network state information relating to the entire network, a portion of the network, or for a particular mobile device. For example, an application server 260 may submit a network state request that identifies a mobile device 210 by its IP address. As another example, an application server 260 may submit a network state request for state information corresponding to a particular geographic area (e.g., the geographic area associated with the user of a particular mobile device 210).

Process 500 may further include providing, to the requesting application servers, the network state information (block 550). In response to a network state request (e.g., as received in block 540), network state server 270 may identify the requested information (e.g., from a database or data structure such as data structures 400 and/or 450), and transmit the requested network state information back to the requesting application server.

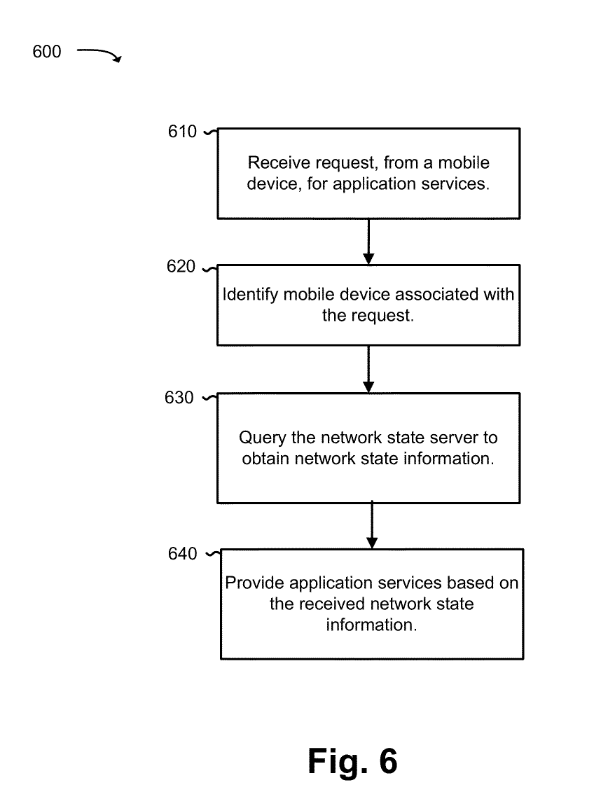

FIG. 6 is a flowchart illustrating an example process 600 for providing application services or data to mobile devices. Process 600 may be performed, for example, by application servers 260.

Process 600 may include receiving requests, from mobile devices, for application services (block 610). As previously mentioned, the application services may include services and/or data that is provided to mobile devices 210.

Process 600 may further include identifying the mobile device associated with the request (block 620). For example, the mobile device may authenticate itself to application server 260. As part of the authentication, the mobile device may provide identification information relating to the mobile device and/or the network (or network portion) to which the mobile device is attached. For example, an application server 260 may receive an IP address of a mobile device, the geographic location of the mobile device, and/or some other information that may be used to identify the mobile device with network state server 270.

Process 600 may further include querying the network state server to obtain network state information (block 630). As previously mentioned, in one implementation, network state server 270 may provide an API through which application servers 260 may obtain the network state information. An application server 260 may use the API to programmatically obtain the network state information. For example, an application server 260 may transmit a request to network state server 270, such as a request that includes the IP address of a mobile device and an indication of the type of network state information that is of interest to the application server (e.g., available bandwidth device, latency of the mobile device corresponding to a wireless network 220, network load associated with the network or network portion to which the mobile device is attached, etc.). In response to the request, application server 260 may receive the requested information.

Process 600 may further include providing application services based on the received network state information (block 640). The received state information may generally be used to modify or optimize the providing of the applications services, such as by modifying the traffic flow communicated between the mobile device and the application server. For example, as previously mentioned, in some implementations, application services may be enhanced or optimized based on the network state information. As one example, for an application service relating to streaming of video to mobile devices 210, the application server 260 may, in response to determining that the network associated with the mobile device is congested, use a lower bandwidth codec to stream the video or delay the streaming of the video until a later date. As another example, for a gaming-related service, application server 260 may determine that latency associated with the network, to which the mobile device is attached, may be too high for an optimal gaming experience and may inform the network device that the gaming service is currently unavailable due to the high network latency. As another example, application servers that are configured to push content to mobile devices 210, may make decisions, relating to when to push the content, based on an amount of network load associated with the network to which the mobile device is attached (e.g., as determined from network state server 270).

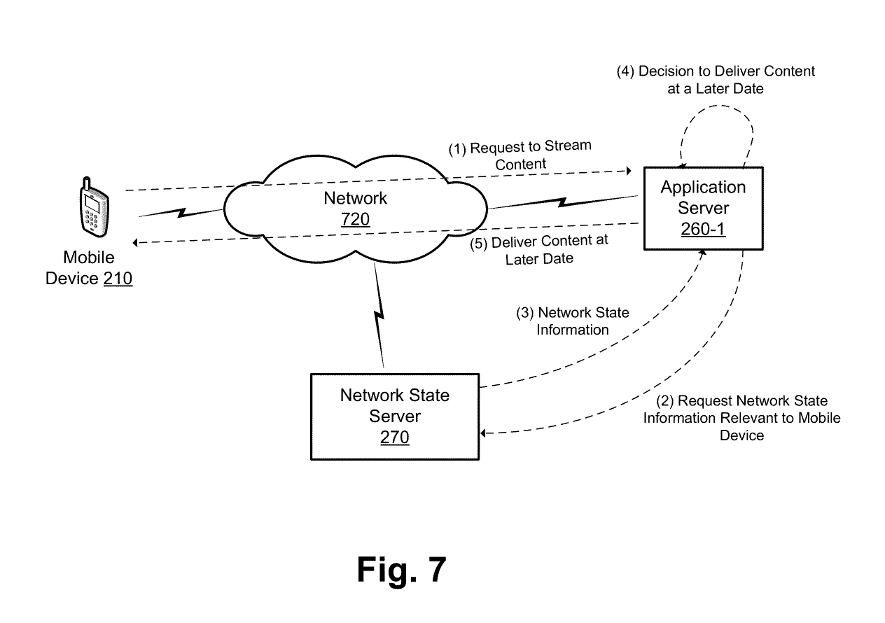

FIG. 7 is a diagram illustrating one particular example of an application server providing services based on network state information that is received from a network state server. As illustrated in FIG. 7, a mobile device 210 may connect, via a network 720 (which may correspond to, for example, wireless network 220), to an application server 260-1. Application server 260-1 may obtain network state information from network state server 270. In this example, assume that application server 260-1 includes a content delivery server for a content delivery network, such as a content delivery server/network that is designed to deliver video content to subscribing devices (e.g., mobile device 210). The video content may be delivered in the background and cached at the subscribing devices for later on-demand playback to the user of the subscribing device.

As shown in FIG. 7, mobile device 210 may transmit a request to obtain content (communication (1), Request to Stream Content) to application server 260-1. The requested content may include, for example, one or more video files, audio files, or other content items. In response to the request for the content, application server 260-1 may obtain network state information from network state server 270. For example, application server 260 -1 may request network state information, relevant to mobile device 210, from network state server 270 (communication (2), Request Network State Information Relevant to Mobile Device). In response, network state server 270 may look up the requested information and return the network state information to application server 260-1 (communication (3), Network State Information).

In this example, assume that the network state information, received by application server 260-1, indicates that network 720 is congested. Based on this, application server 260-1 may determine to deliver the requested content at a later date (communication (4), Decision to Deliver Content at a Later Date). In this way, application server 260-1 can use the network state information to make informed decisions relating to the use of network 720 to communicate with mobile device 210. At the later date, which may correspond to better network conditions in network 720, the requested content may be delivered from application server 260-1 to mobile device 210 (communication (5), Deliver Content at Later Date). As another example, assume that the requested content is content that the user of mobile device 210 would like to view immediately as streaming content. In this case, application server 260-1 may still deliver the content, but may deliver the content using a lower bandwidth content stream.

In the above description, network state information was described as being maintained and distributed by a network state server. In an alternate or additional possible implementation, the network state information may be maintained by a process executing at mobile device 210. The process, at mobile device 210, may provide a network state API through which applications local to the mobile device 210 and/or remote applications, such as applications provided by application servers 260, may access the network state information.

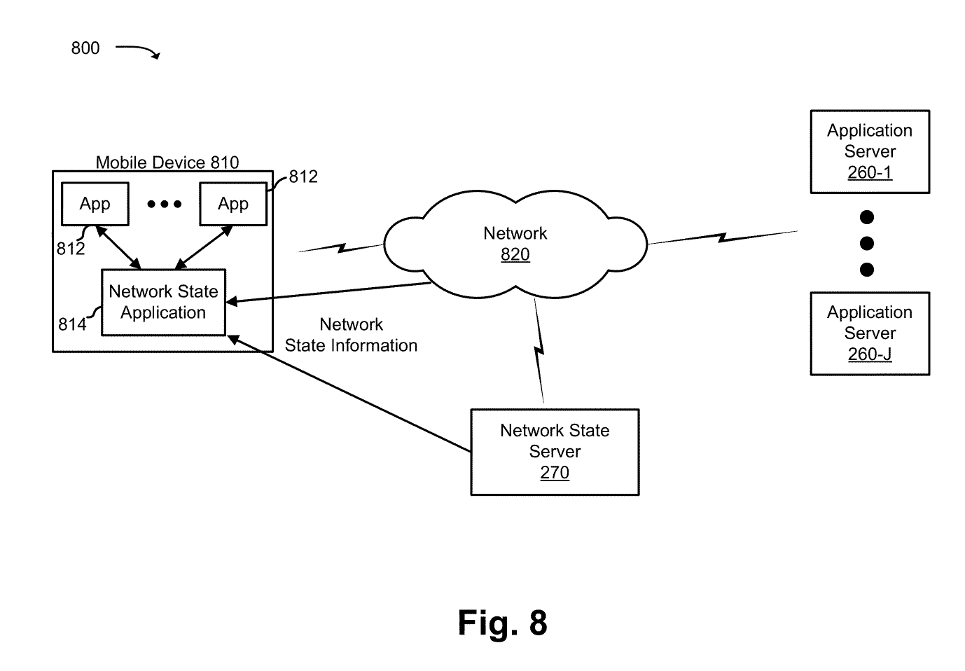

FIG. 8 is a diagram illustrating an example system 800 in which network state information may be maintained by a mobile device. As illustrated, a mobile device 810 may communicate, via a network 820, with devices such as application servers 260 and a network state server 270. Mobile device 810 may be similar to device 210 (FIG. 2) and network 820 may, in some implementations, represent wireless network 220.

As shown in FIG. 8, mobile device 810 may include a number of applications 812 that may communicate with network state application 814. Applications 812 may include user-installed applications, applications distributed with mobile device 810, or other applications, that execute locally at mobile device 810. Network state application 814 may include an application that may store and provide network state information, such as network state information relating to the operational state of network 820 with respect to the connection of mobile device 810 to network 820. Applications 812 may access network state application 814 through, for example, an API provided by network state application 814. Applications 812 may use the network state information to optimize or enhance the operation of applications 812.

Network state application 814 may maintain or store network state information in a manner similar to the network state information maintained by network state server 270. In one implementation, network state application 814 may receive network state information from network state server 270. Alternatively or additionally, networks state application 814 may obtain network state information directly from network 820. For example, network state application 814 may issue ping requests to network 820 to obtain latency information and/or may monitor signal-to-noise ratios, RF signal strength values, or other information that may be used to quantify the quality of communication sessions that may be implemented through network 820. In some implementations, network state application 814 may transmit messages, to network state server 270, that include the network state information that is determined by network state application 814.

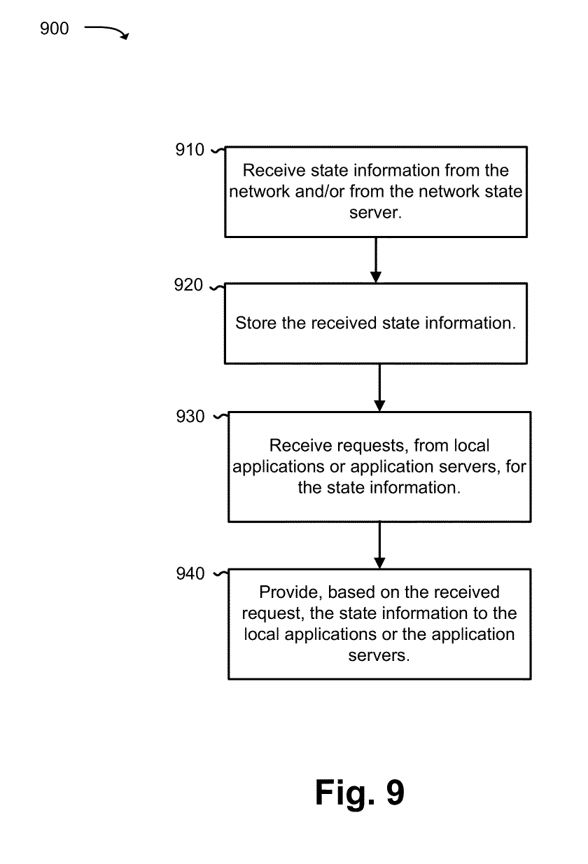

FIG. 9 is a flowchart illustrating an example process 900 for providing network state information to application servers 260. Process 900 may be performed, for example, by network state application 814.

Process 900 may include receiving state information from the network and/or from the network state server (block 910). In some implementations, a mobile device, such as mobile device 810, may obtain state information from the network, such as by explicitly querying network devices and/or based on network status or diagnostic information obtained as part of the normal operation of mobile device 810. For example, mobile device 810 may read current conditions associated with the radio interface, such as latency determined through ping messages, a value of the received signal strength indicator (RSSI), etc. In some implementations, network state application 814 may additionally obtain network state information from network state server 270 and/or provide network state information to network state server 270.

Process 900 may further include storing the received state information (block 920). For example, network state application 814 may maintain one or more data structures to store the state information. Network state application 814 may make the stored information available, such as via an API that can accessed by applications 812 and application servers 260.

Process 900 may further include receiving requests, from local applications or the application servers, for the network state information (block 930). In some implementations, applications 812 may use the network state information to enhance or optimize services provided by applications 812. For example, applications 812 may refrain from requesting or transmitting a bandwidth intensive file when network 820 is heavily loaded or the RF conditions are poor. Applications 812 may transmit requests, using the API provided by network state application 814, for the network state information. Similarly, application servers 260 may use the network state information to enhance or optimize services or data delivered to mobile device 810. Application servers 260 may request the network state information from network state application 814.

Process 900 may further include providing, based on the received request, the state information to the local applications or to the application servers (block 940). For example, through the API provided by network state application 814, the requested network state information may be provided to applications 812 and/or application servers 260. Applications 812 and/or application servers 260 may use the network state information to optimize and/or enhance operations of the applications 812 and/or application servers 260. For example, applications 812, such as applications 812 that operate as background applications, may schedule activity based on the received network state information.

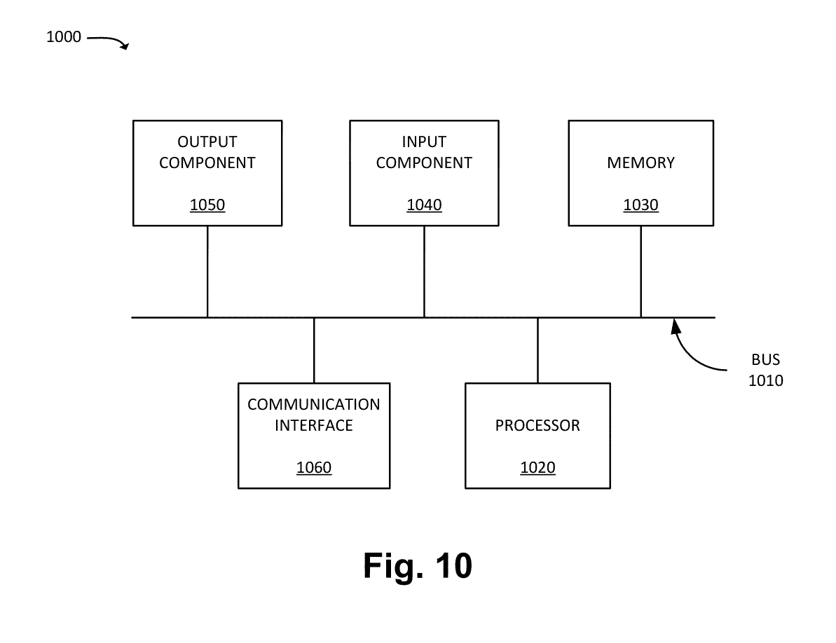

FIG. 10 is a diagram of example components of a device 1000. Each of the devices illustrated in FIGS. 1-3, 7, and 8 may include one or more devices 1000. Device 1000 may include bus 1010, processor 1020, memory 1030, input component 1040, output component 1050, and communication interface 1060. In another implementation, device 1000 may include additional, fewer, different, or differently arranged components.

Bus 1010 may include one or more communication paths that permit communication among the components of device 1000. Processor 1020 may include a processor, microprocessor, or processing logic that may interpret and execute instructions. Memory 1030 may include any type of dynamic storage device that may store information and instructions for execution by processor 1020, and/or any type of non-volatile storage device that may store information for use by processor 1020.

Input component 1040 may include a mechanism that permits an operator to input information to device 1000, such as a keyboard, a keypad, a button, a switch, etc. Output component 1050 may include a mechanism that outputs information to the operator, such as a display, a speaker, one or more light emitting diodes (“LEDs”), etc.

Communication interface 1060 may include any transceiver-like mechanism that enables device 1000 to communicate with other devices and/or systems. For example, communication interface 1060 may include an Ethernet interface, an optical interface, a coaxial interface, or the like. Communication interface 1060 may include a wireless communication device, such as an infrared (“IR”) receiver, a Bluetooth radio, or the like. The wireless communication device may be coupled to an external device, such as a remote control, a wireless keyboard, a mobile telephone, etc. In some embodiments, device 1000 may include more than one communication interface 1060. For instance, device 1000 may include an optical interface and an Ethernet interface.

Device 1000 may perform certain operations described above. Device 1000 may perform these operations in response to processor 1020 executing software instructions stored in a computer-readable medium, such as memory 1030. A computer-readable medium may be defined as a non-transitory memory device. A memory device may include space within a single physical memory device or spread across multiple physical memory devices. The software instructions may be read into memory 1030 from another computer-readable medium or from another device. The software instructions stored in memory 1030 may cause processor 1020 to perform processes described herein. Alternatively, hardwired circuitry may be used in place of or in combination with software instructions to implement processes described herein. Thus, implementations described herein are not limited to any specific combination of hardware circuitry and software.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

For example, while series of blocks have been described with regard to FIGS. 5, 6, and 9, the order of the blocks may be modified in other implementations. Further, non-dependent blocks may be performed in parallel.

It will be apparent that example aspects, as described above, may be implemented in many different forms of software, firmware, and hardware in the implementations illustrated in the figures. The actual software code or specialized control hardware used to implement these aspects should not be construed as limiting. Thus, the operation and behavior of the aspects were described without reference to the specific software code—it being understood that software and control hardware could be designed to implement the aspects based on the description herein.

Further, certain portions of the invention may be implemented as “logic” that performs one or more functions. This logic may include hardware, such as an ASIC or a FPGA, or a combination of hardware and software.

Even though particular combinations of features are recited in the claims and/or disclosed in the specification, these combinations are not intended to limit the invention. In fact, many of these features may be combined in ways not specifically recited in the claims and/or disclosed in the specification.

No element, act, or instruction used in the present application should be construed as critical or essential to the invention unless explicitly described as such. Further, the phrase “based on” is intended to mean “based, at least in part, on” unless explicitly stated otherwise.

What is claimed is:

1. A method comprising:
receiving, by one or more computing devices, state information relating to an operational state of a network with respect to providing of network services to mobile devices connected to the network, the state information including:
information relating to the operational state of a particular portion of the network; or
information relating to the operational state of the network as relevant to a particular mobile device connected to the network;
receiving, by the one or more devices, a request for the state information from an application server that provides services based on the state information, the request including an identification of the particular portion of the network or an identification of the particular mobile device; and
providing, by the one or more devices, the requested state information to the application server.

2. The method of claim 1, further comprising:
providing an application program interface (API), to the application server, to receive the request from the application server.

3. The method of claim 1, further comprising:
receiving the state information from one or more network devices in the network.

4. The method of claim 3, wherein the one or more network devices in the network include a base station.

5. The method of claim 1, further comprising:
receiving the state information from the mobile devices.

6. The method of claim 1, wherein the network includes a long term evolution (LTE) wireless network.

7. The method of claim 1, wherein the operational state of the particular portion of the network includes an operational state of a particular geographic area or of an area corresponding to an area serviced by a base station in a wireless network.

8. The method of claim 1, wherein the state information includes at least one of:
an indication of a radio frequency signal strength associated with the mobile devices;
an indication of a bandwidth associated with the mobile devices; or
an indication of latency associated with the mobile devices.

9. A device comprising:
a memory; and
at least one processor to execute instructions in the memory to:
receive state information relating to an operational state of a network with respect to providing of network services to mobile devices connected to the network, the state information including:
information relating to the operational state of a particular portion of the network; or
information relating to the operational state of the network as relevant to a particular mobile device connected to the network;
receive a request for the state information from an application server that provides services based on the state information, the request including an identification of the particular portion of the network or an identification of the particular mobile device; and
provide the requested state information to the application server.

10. The device of claim 9, further comprising:
providing an application program interface (API), to the application server, to receive the request from the application server.

11. The device of claim 9, wherein the at least one processor is to further execute instructions in the memory to receive the state information from one or more network devices in the network.

12. The device of claim 9, wherein receiving the state information includes receiving the state information from the mobile devices.

13. The device of claim 9, wherein the operational state of the particular portion of the network includes an operational state of a particular geographic area or of an area corresponding to an area serviced by a base station in a wireless network.

14. The device of claim 9, wherein the state information includes at least one of:
an indication of a radio frequency signal strength associated with the mobile devices;
an indication of a bandwidth associated with the mobile devices; or
an indication of latency associated with the mobile devices.

15. A method comprising:
receiving, by one or more computing devices, a request, from a mobile device, for an application service;
receiving, by the one or more computing devices and from the mobile device, identification information relating to the mobile device;
transmitting, by the one or more computing devices and to a network state server, a request for network state information relating to an operational state of a wireless network, to which the mobile device is attached, the request including the identification information relating to the mobile device;
receiving, by the one or more computing devices, the requested network state information as information relating to the operational state of the wireless network and that is relevant to the mobile device; and
providing, by the one or more computing devices and via the wireless network, the application service, the application service being provided based on the received network state information.

16. The method of claim 15, wherein the network state information includes at least one of:
an indication of a radio frequency signal strength associated with the mobile device;
an indication of a bandwidth associated with the mobile device; or
an indication of latency associated with the mobile device.

17. The method of claim 15, wherein the application service includes a content delivery service.

18. The method of claim 15, wherein the identification information includes an Internet Protocol (IP) address associated with the mobile device.

19. The method of claim 15, further comprising:
querying the mobile device for additional state information relating to the operational state of the wireless network; and
using the additional state information to provide the application service.

20. The method of claim 15, wherein the identification information includes information relating to a portion of the wireless network.
